(19) United States
(12) Patent Application Publication
(10) Pub. No.: US 2009/0273778 A1
(43) Pub. Date: Nov. 5, 2009

(54) SURFACE ENHANCED RESONANT RAMAN SPECTROSCOPY

(75) Inventors: Sieglinde Neerken, Eindhoven (NL); Gerhardus Wilhelmus Lucassen, Eindhoven (NL); Kristiane Anne Schmidt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/296,694

(22) PCT Filed: Apr. 6, 2007
(86) PCT No.: PCT/IB07/51251

§ 371 Date: Oct. 10, 2008

(30) Foreign Application Priority Data
Apr. 13, 2006 (EP) 06300360.2

(51) Int. Cl. G01J 3/44

(52) U.S. Cl. 356/301

(57) ABSTRACT

A method of performing surface-enhanced resonant Raman spectroscopy (SERRS) in respect of a sample (100) provided on an aggregated colloid nano-particle having a plasmon absorption band similar to that of a target molecule. The sample is irradiated at a first wavelength (λ₁).coinciding with the absorption band of the plasma, to obtain (12) a SERRS spectra for deriving (10) a fingerprint of the target melecule, and at a second wavelength (λ₂), coinciding with the absorption band caused by aggregate of said nano- particles, to obtain (14) a SERS spectra for monitoring (16) said aggregation.

This invention relates to a method and apparatus for performing surface-enhanced resonant Raman spectroscopy (SERRS) for use in the detection of (bio)molecules, such as in the field of molecular diagnostics.

Raman spectroscopy is a popular, non-destructive tool for structural characterisation of carbons, in which Raman scattering of light by molecules may be used to provide information on a sample's chemical composition and molecular structure. Surface enhanced Raman spectroscopy (SERS) is a type of Raman spectroscopic (RS) technique that provides a greatly enhanced Raman signal from Raman-active analyte molecules that have been adsorbed onto certain, specially-prepared metal surfaces. RS is ineffective for surface studies because the photons of the incident laser light simply propagate through the bulk and the signal from the bulk overwhelms any Raman signal from the analytes at the surface. SERS, on the other hand, is both surface selective and highly sensitive, and its selectivity of the surface signal results from the presence of surface enhancement (SE) mechanisms only at the surface.

There are two primary mechanisms of enhancement described in the literature: electromagnetic and chemical enhancement respectively. The effect of electro magnetic enhancement tends to be dominant and is dependent on the presence of roughness features on the metal surface, the roughness features being of the order of tens of nanometers; small, compared to the wavelength of the incident excitation radiation.

Surface-enhanced resonant Raman Spectroscopy (SERRS) is a technique that can be used for sensitive and selective detection and identification of molecules adsorbed at a roughened metal surface, wherein Resonance Raman Spectroscopy provides a further enhancement to SERS. In this case, enhancement of the Raman signal is achieved by selection of the laser excitation wavelength to coincide with the absorption band of a specific dye. The Resonance Raman effect will be known to a person skilled in the art.

Using SERRS, it is possible to combine the sensitivity of molecular resonance (by the above-mentioned specific dye) with the sensitivity of surface enhanced Raman scattering (SERS) so that very low concentrations can be measured. The technique can, for example, be applied in molecular diagnostics to identify deoxyribonucleic acid (DNA) of pathogen bacteria or proteins involved in infectious diseases. In this case, rapid and highly sensitive identification is crucial for effective treatment, and optical methods, especially fluorescence spectroscopy, are widely used to identify certain biomolecules. However, SERRS has the unique feature that the scattered light consists of sharp, molecule-specific vibrational bands which makes discrimination of multiple analytes possible, and DNA identification by Surface-enhanced resonant Raman Spectroscopy carried out with a solid substrate metal surface is known from, for example, ‘Near-Field Surface-enhanced Raman Imaging of Dye-Labelled DNA with 100-nm Resolution’, Volker Dechert et al, Anal. Chem., 70 (13), 2646-2650, 1998.

Adsorption of target analytes on the surface can, however, be very slow due to the process of diffusion. Further enhancement of the technique has therefore been proposed using colloids aggregated by a reduction in surface charge, which results in areas of high electric field in the interstices. For this purpose, Raman-active nano-particles have been developed which combine the SERRS dye with a reduced (e.g. Silver) colloid, and experiments with aggregated colloids have shown very promising results (see, for example, ‘A comparison of surface enhanced resonance Raman scattering from unaggregated and aggregated nano-particles’, by K. Faulds et al, Anal. Chem., 2004, 76, 592-59).

One problem that has been encountered when using SERRS with nano-particles lies in the control of the aggregation process of the particles. SERRS experiments with aggregated colloids have shown that the signal intensity varies with time. The signal strength depends on the size of the aggregates and it has been determined that maximum signal intensity can be obtained after approximately 1 minute (see ‘Detection and identification of labelled DNA by SERRS’, by D. Graham et al, Biopolymers (Biospectroscopy) 2000, 57, 85-91).

It is therefore an object of the present invention to provide a method for performing Surface-Enhanced resonant Raman Spectroscopy (SERRS) using aggregated nano-particles, wherein the aggregation state of the nano-particles can be monitored so as to increase the specificity, sensitivity and reproducibility of Surface-Enhanced Resonant Raman Spectroscopy (SERRS).

In accordance with the present invention, there is provided a method of performing surface-enhanced resonant Raman spectroscopy in respect of a sample containing a target molecule, the method comprising providing said sample on the surface of a nano-particle comprising an aggregated colloid having a plasmon absorption band similar to said target molecule, the method further comprising irradiating said sample with radiation of at least two excitation wavelengths and obtaining the resultant spectra, wherein said first excitation wavelength coincides with the said plasmon absorption band and said second excitation wavelength coincides with the absorption band caused by aggregation of said nano-particles.

Beneficially, the method includes the step of analysing the spectra obtained at different times as a result of said second excitation wavelength so as to monitor the aggregate state over time of said colloid. This enables the adsorption signal to be characterised and the reproducibility of the measurement to be checked. In addition, the spectra obtained at different times as a result of the second excitation wavelength can be used get information on possible other molecules (e.g. contaminations) in the sample that adsorb at the metal surface and may influence the SERRS labels.

The spectra obtained as a result of the second excitation wavelength may comprise the surface-enhanced Raman spectroscopy (SERS) signal intensity spectra or the absorption signal of aggregation states at λ₂ of said colloid at respective different times.

In one exemplary embodiment, the sample may be irradiated at multiple wavelengths within said plasmon absorption band. In this case, the excitation wavelength may be scanned through the plasmon absorption band, which results in a SERRS-excitation spectrum that can give specific information on various transitions.

Thus, the invention provides a method to increase the specificity, sensitivity and reproducibility of surface-enhanced resonant Raman spectroscopy. By using a multi-wavelength method, the aggregation state of colloids (employed to achieve signal enhancement) can be monitored contributing to a controlled and reproducible measurement method. The monitoring can be used to check reproducibility. By analysing these spectra the adsorption signal can be characterised. In addition, an independent background can be obtained by employing multi-wavelength excitation; this gives information on possible other components (besides the SERRS labels) in the sample. In another approach, more specific information can be obtained while scanning the excitation wavelength through the absorption band and measuring and combining the corresponding SERRS spectra.

This is particularly relevant for the ultra-sensitive detection of (bio)molecules, such as in the field of molecular diagnostics.

These and other aspects of the present invention will be apparent from, and elucidated with reference to, the embodiments described herein.

Embodiments of the present invention will now be described by way of examples only, and with reference to the accompanying drawings, in which:

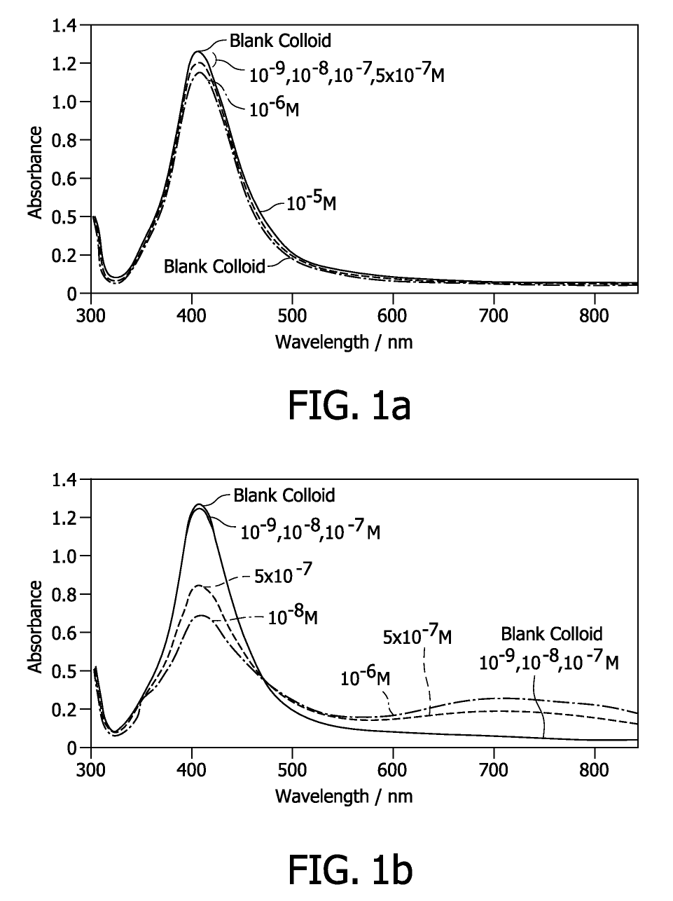

FIG. 1a illustrates graphically a single absorption band due to unaggregated silver particles;

FIG. 1b illustrates graphically the absorption spectrum of aggregated silver colloids depending on the aggregation state, and extra absorption band in the infra-red appears;

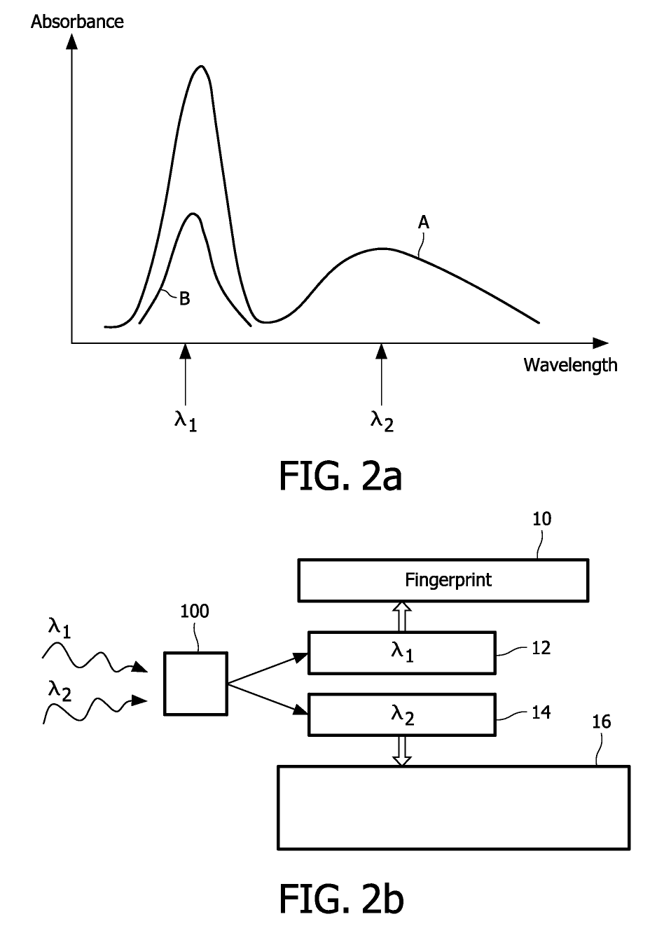

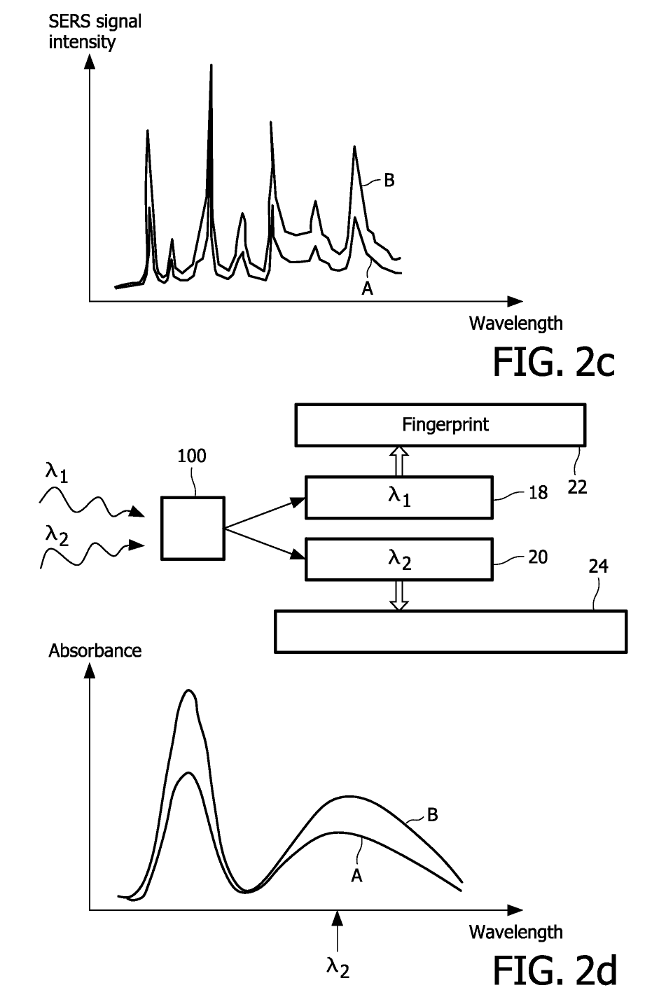

FIG. 2 illustrates graphically the absorption spectrum of aggregated colloids [curve A] and of dye [curve B] (not to scale), with excitation wavelengths indicated for use in a method according to an exemplary embodiment of the invention;

FIG. 2b is a schematic block diagram illustrating the principal steps of a method according to an exemplary embodiment of the present invention;

FIG. 2c illustrates graphically the SERS spectra of different aggregation states [curve A: aggregation state 1; curve B: aggregation state 2] at different measurement times of a method according to an exemplary embodiment of the present invention;

FIG. 2d is a schematic block diagram illustrating the principal steps of a method according to an exemplary embodiment of the invention, and a graphical illustration of the resultant absorption spectra of different aggregation states [curve A: absorption spectrum of aggregate state 1; curve B: absorption spectrum of aggregation state 2];

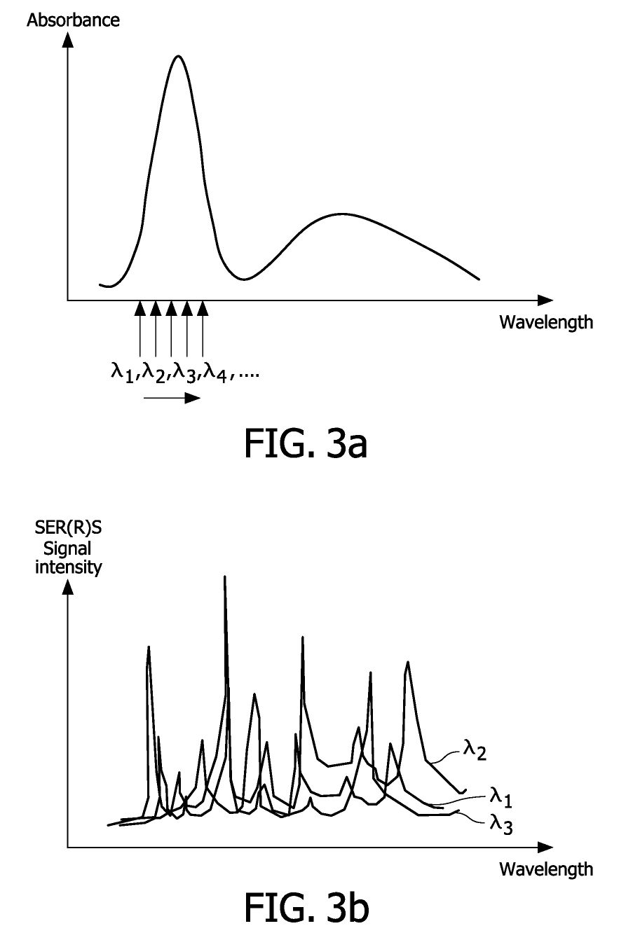

FIG. 3a illustrates graphically the SERRS excitation spectra with multi-wavelength excitation used in a method according to an exemplary embodiment of the present invention; and

FIG. 3b illustrates graphically the detection of SERRS signals upon excitation with different wavelengths.

By way of background, and as explained above, when a compound is illuminated with an appropriate light source, the vast majority of reflected photons are emitted with identical energy (frequency) as the incident light (Rayleigh scattering). However, a small number of photons emerge with altered energy levels resulting in a phenomenon known as ‘Raman Scattering’. This inelastic scattering in which the photons both gain (anti-Stokes shift) and lose (Stokes shift) energy relative to the incident light, is caused by vibrational interaction between individual photons and the chemical moieties within the sample compound. As no two compounds display identical Raman responses, Raman spectroscopy has historically been a valuable analytical tool for educating chemical structure.

While Raman scattering has always been considered a weak signal effect, requiring dedicated and highly sensitive instrumentation for its detection, its signal detection can be significantly enhanced by two specific modifications. Firstly, intimate association of the compound of interest with a fractally-rough metal (usually gold or silver) results in 5-6 orders of magnitude signal amplification mediated by the metal surface plasmon (SERS). In addition to this surface enhancement, further signal amplification is possible if the excitation wavelength is resonant with both the plasmon band and the associated compound. This ‘Resonant’ enhancement contributes on additional 3-4 orders of magnitude to the Raman intensity. This synergistic enhancement (SERRS) brings Raman spectroscopy into sensitivity ranges of fluorescence and beyond.

However, unlike fluorescence with its extensive spectral overlap and limited palette, a SERRS spectrum has narrow peak bandwidths, offering good spectral resolution, and is unique for any compound. Therefore, extensive numbers of unique labels are possible resulting in high multiplex capability.

SERRS can be further enhanced using aggregated colloids, wherein, for example, the SERRS dye is added to a reduced (e.g. silver) colloid and the aggregation can be achieved by an aggregation agent, e.g. spermine, LiCl, NaCl. Referring to FIG. 1a of the drawings, the electronic absorption spectrum of unaggregated nano-particles shows a single band (at around 400 nm in this case). If, on the other hand, the particles are aggregating, a second red-shifted absorption band appears (around 700 nm in this case), while the band around 400 nm decreases, as shown in FIG. 1b.

In summary, therefore, SERS signals can be obtained by excitation into the electronic absorption band. If a dye is adsorbed on the surface, an extra absorption band of the dye and the absorption band of the (aggregated or unaggregated) nano-particles and a SERRS signal can be detected. In the case of aggregated particles, an increase in signal intensity compared to the single-particle value of a factor of 6 can be obtained.

It is proposed herein to combine SERS and SERRS in aggregated nano-particles by multi-wavelength excitation of a sample 100 (and referring to FIGS. 2a and 2b of the drawings):
1. The first excitation wavelength λ₁ coincides with the absorption band of the dye and the nano-particles. This results in the detection (step 12) of a SERRS signal with large enhancement. This signal will be used to derive (step 10) a fingerprint of the (bio)molecule of interest.
2. The second excitation wavelength λ₂ coincides with the red-shifted absorption band caused by the aggregation of the nano-particles. This results in the detection (step 14) of a SERS signal.

Thus, FIG. 2b is a schematic drawing of a multi-wavelength excitation and detection of SERRS and SERS signal and the corresponding information that can be derived. The proposed sample includes aggregated colloids with dye labels and biomolecules of interest (SERRS labels).

If the SERS signal is monitored (over time) the aggregation state can be evaluated (step 16). The strength of the signal depends on the degree of aggregation, because the strength of the red-shifted absorption band depends on the degree of aggregation. Without aggregation no absorption and consequently no SERS signal can be monitored. The signal intensity is monitored at, at least one wavelength, as illustrated in FIG. 2c. The resultant λ₂ spectra can simultaneously be used as independent background spectra to observe other possible molecules in the sample that adsorb at the metal surface.

Alternatively, the absorption signal (in a transmission measurement) due to the aggregated nano-particles can be followed in time to evaluate the aggregation state, as illustrated in FIG. 2d. However, using SERS analysis the spectra can also give a clue on the type of particles adsorbed on the surface. Once again, the resultant λ₂ spectra can simultaneously be used as independent background spectra to obtain information on possible other molecules in the sample that adsorb at the metal surface.

Thus, in general, another aspect of the multi-wavelength excitation method is that the SERS signal obtained by excitation λ₂ can be used to generate an independent background signal that can be used to observe possible other molecules in the sample that adsorb at the metal surface. This increases the accuracy of the method.

Scanning the excitation wavelength through the absorption band can target another aspect of a multi-wavelength excitation method. This results in a SERRS-excitation spectrum that can give specific information on various transitions. The SERRS spectrum will change with scanning the wavelength. This yields increased spectral specificity to detect target molecules compared to excitation at a single wavelength, because resonance enhancement is characteristic for different molecular vibrations at different excitation wavelengths. This is applicable in experiments with solid substrate metal surfaces and in nano-particle colloid aggregates, and is illustrated in FIGS. 3a and 3b. Instead of measuring a spectrum, the information can be measured at specifically selected wavelengths.

The application can be applied in molecular diagnostics, such as the bacterial detection of DNA by SERRS. Other applications can be found in analyte detection in complex media or in monitoring analyte concentrations in complex media such as in drug monitoring in body fluids, or in chemical analysis processes.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of performing surface-enhanced resonant Raman spectroscopy in respect of a sample (100) containing a target molecule, the method comprising providing said sample (100) on the surface of a nano-particle comprising an aggregated colloid having a plasmon absorption band similar to said target molecule, the method further comprising irradiating said sample with radiation of at least two excitation wavelengths and obtaining the resultant spectra, wherein said first excitation wavelength (λ₁) coincides with said plasmon absorption band and said second excitation wavelength (λ₂) coincides with the absorption band caused by aggregation of said nano-particles.

2. A method according to claim 1, further including the step of analysing (16, 24) the spectra obtained at different times as a result of said second wavelength (λ₂) so as to monitor the aggregation state over time of said colloid.

3. A method according to claim 1, wherein the spectra obtained at different times as a result of the second excitation wavelength (λ₂) are used to generate an independent background signal.

4. A method according to claim 1, wherein a fingerprint of said molecule is derived (10) from the spectra obtained as a result of said first excitation wavelength (λ₁).

5. A method according to claim 1, wherein spectra obtained as a result of the second excitation wavelength (λ₂) comprise the surface-enhanced Raman spectroscopy (SERS) signal intensity spectra or the absorption signal of aggregation states of said colloid at respective different times.

6. A method according to claim 1, wherein said sample (100) is irradiated at multiple wavelengths (λ₁, λ₂, λ₃, λ₄ . . . ) within said plasmon absorption band.
